(19) United States
(12) Patent Application Publication
(10) Pub. No.: US 2026/0313514 A1
(43) Pub. Date: Oct. 8, 2026

(54) RELAY APPARATUS, CONTROL METHOD, AND STORAGE MEDIUM STORING PROGRAM

(71) Applicant: CANON KABUSHIKI KAISHA, Tokyo (JP)

(72) Inventor: TETSUYA KATSURAGI, Tokyo (JP)

(21) Appl. No.: 19/635,540

(22) Filed: Mar. 31, 2026

(30) Foreign Application Priority Data
Apr. 8, 2025 (JP) 2025-063922

(51) Int. Cl. H04W 40/22; H04W 88/04

(52) U.S. Cl. CPC H04W 40/22; H04W 88/04

(57) ABSTRACT

A first apparatus is configured to relay communication between a first terminal apparatus and a second terminal apparatus, and includes a decision unit configured to decide to switch a communication method by which the first terminal apparatus and the second terminal apparatus communicate with each other between a first communication method for communicating via a base station and a second communication method for communicating without intervention of the base station, and a transmission unit configured to, based on the decision unit deciding to switch the communication method between the first communication method and the second communication method, transmit a signal related to a second apparatus configured to relay communication of the switched communication method between the first terminal apparatus and the second terminal apparatus.

### BACKGROUND

### Field of the Technology

The aspect of the embodiments relates to a relay apparatus, a control method, and a storage medium storing a program.

### Description of the Related Art

The Third Generation Partnership Project (3GPP [registered trademark]) has stipulated cellular communication standards (also referred to as 3GPP standards). In recent years, the specifications of 3GPP Long Term Evolution (LTE) and New Radio (NR) have been being formulated.

In 3GPP, a specification has been stipulated in which a communication path (or communication) between user equipments (UEs) is switched between a path connected via a base station (Uu path) and a directly connected path (PC5 path). UEs may also be referred to as terminal apparatuses or simply terminals.

Japanese Patent Laid-Open No. 2016-106449 discusses a technique for switching a connection between terminals from a direct connection to a connection via a base station.

In 3GPP, the specification of the Fifth Generation (5G) Proximity-based Services (ProSe) UE-to-UE relay has also been being formulated. UE-to-UE relay is a mechanism for relaying a communication path (or communication) between terminal apparatuses using a relay apparatus (UE-to-UE relay terminal) in sidelink communication where two terminal apparatuses (end UEs) communicate directly with each other without the intervention of a base station.

A communication path between UEs may therefore be switched between paths where a UE-to-UE relay terminal (or candidate thereof) can intervene. A UE-to-UE relay terminal may also be referred to as a sidelink relay terminal, a relay UE, a relay, etc.

Meanwhile, in 3GPP, the specification of 5G ProSe UE-to-network element (UE-to-NE) relay has also been being formulated. UE-to-NE relay is a mechanism in which a terminal apparatus and a relay apparatus (UE-to-NE relay terminal) perform sidelink communication with each other, whereby the UE-to-NE relay terminal relays a communication path (or communication) between the end UE and a base station.

A communication path between UEs may therefore be switched between paths where a UE-to-NE relay terminal (or candidate thereof) can intervene. A UE-to-NE relay terminal may also be referred to as a sidelink relay terminal, a relay UE, a relay, etc.

However, operations related to the switching of paths where a UE-to-UE relay terminal can intervene are not specified or clarified. Operations related to the switching of paths where a UE-to-NE relay terminal can intervene are not specified or clarified, either.

### SUMMARY

According to an aspect of the disclosure, a first apparatus is configured to relay communication between a first terminal apparatus and a second terminal apparatus, and includes a decision unit configured to decide to switch a communication method by which the first terminal apparatus and the second terminal apparatus communicate with each other between a first communication method for communicating via a base station and a second communication method for communicating without intervention of the base station, and a transmission unit configured to, based on the decision unit deciding to switch the communication method between the first communication method and the second communication method, transmit a signal related to a second apparatus configured to relay communication of the switched communication method between the first terminal apparatus and the second terminal apparatus.

Features of the disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration example of a communication system according to a first embodiment.

FIG. 2 is a block diagram illustrating a functional configuration example of terminal apparatuses according to the first embodiment.

FIG. 3 is a diagram illustrating a functional configuration example of sidelink relay terminal apparatuses according to the first embodiment.

FIG. 4 is a sequence diagram illustrating a processing example when switching from a user equipment-to-user equipment (UE-to-UE) relay path to a Uu path (UE-to-network element [UE-to-NE] relay path) according to the first embodiment.

FIG. 5 is a sequence diagram illustrating a processing example when switching from a Uu path (UE-to-NE relay path) to a UE-to-UE relay path according to the first embodiment.

FIG. 6 is a flowchart illustrating a processing example when a UE-to-UE relay terminal determines to switch from a UE-to-UE relay path to another PC5 path or a Uu path (UE-to-NE relay path) according to the first embodiment.

FIG. 7 is a flowchart illustrating a processing example when a UE-to-NE relay terminal determines to switch from a Uu path (UE-to-NE relay path) to a UE-to-UE relay path according to the first embodiment.

FIG. 8 is a diagram illustrating a configuration example of a communication system according to a second embodiment.

FIGS. 9A and 9B are sequence diagrams illustrating a processing example when switching from a UE-to-UE relay path to a Uu path (UE-to-NE relay path) according to the second embodiment.

FIG. 10 is a sequence diagram illustrating a processing example when switching from a Uu path (UE-to-NE relay path) to a UE-to-UE relay path according to the second embodiment.

FIG. 11 is a diagram illustrating a configuration example of a communication system according to a third embodiment.

FIG. 12 is a sequence diagram illustrating a processing example when switching from a UE-to-UE relay path to a Uu path (UE-to-NE relay path) according to the third embodiment.

FIG. 13 is a sequence diagram illustrating a processing example when switching from a Uu path (UE-to-NE relay path) to a UE-to-UE relay path according to the third embodiment.

### DESCRIPTION OF THE EMBODIMENTS

Embodiments will be described in detail below with reference to the attached drawings. The following embodiments are not intended to limit the scope of the claims. While a plurality of features is described in the embodiments, not all of such features are necessarily essential to the disclosure, and the features may be freely combined. In the attached drawings, the same or similar components are denoted by the same reference numerals, and redundant descriptions may be omitted.

### First Embodiment

### System Configuration

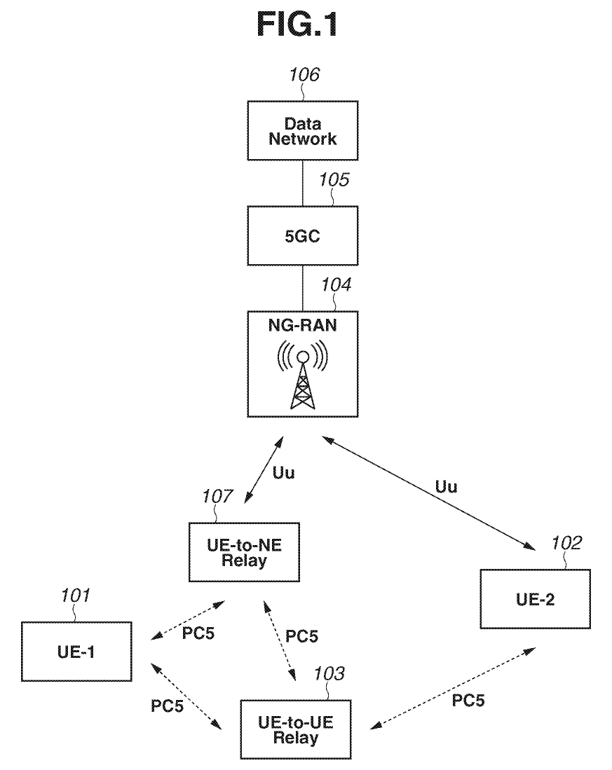

FIG. 1 is a diagram illustrating a configuration example of a communication system according to a first embodiment of the disclosure. The communication system illustrated in FIG. 1 according to the embodiment provides Proximity-based Services (ProSe) that enable user equipments (UEs) to communicate directly with each other. ProSe may be referred to as device-to-device (D2D) services. This enables, for example, improvement in frequency use efficiency and overall throughput, a reduction in UE power consumption, and the like. UEs described below support ProSe, and may be referred to as ProSe UEs or ProSe-enabled UEs.

While the embodiment deals with the Fifth Generation (5G), the disclosure is also applicable to systems other than 5G (for example, next-generation mobile communication systems such as 5G Advanced and the Sixth Generation , Long Term Evolution [LTE], LTE-Advanced, combinations thereof, and the like).

As illustrated in FIG. 1, an exemplary communication system includes a UE-1 101, a UE-2 102, a UE-to-UE relay terminal 103, and a Next Generation Radio Access Network (NG-RAN) 104.

The exemplary communication system also includes a 5G Core Network (5GC) 105, a data network 106, and a UE-to-network element (UE-to-NE) relay terminal 107.

The UE-1 101 and the UE-2 102 are terminals having a communication function with a base station in a 5G mobile communication network (or 5G mobile communication system) and a direct communication (sidelink communication) function with other terminals. The UE-1 101 and the UE-2 102 communicate with a base station (such as the NG-RAN 104) via Uu paths. The UE-1 101 and the UE-2 102 communicate with other terminals (such as the UE-to-UE relay terminal 103 and the UE-to-NE relay terminal 107) via PC5 paths.

The UE-to-UE relay terminal 103 is a relay apparatus (relay terminal) that relays sidelink communications between terminals to extend sidelink communication coverage.

The NG-RAN 104 is a base station that performs wireless communication with terminals in the 5G mobile communication network.

The 5GC 105 controls 5G mobile communications.

The data network 106 is an external network connected to the 5G mobile communication network, such as the Internet.

The UE-to-NE relay terminal 107 is a relay apparatus (relay terminal) that connects to terminals via PC5 paths, connects to a base station (for example, the NG-RAN 104) via a Uu path, and relays sidelink communications from the terminals. The UE-to-NE relay terminal 107 and the UE-to-UE relay terminal 103 communicate via a PC5 path. The UE-to-NE relay terminal 107 and the base station (such as the NG-RAN 104) communicate via a Uu path.

As will be described in detail below, the UE-to-UE relay terminal 103 decides to switch the communication method for communication between the UE-1 101 and the UE-2 102 as follows. The UE-to-UE relay terminal 103 decides to switch the communication method to one in which communication is performed via the UE-to-NE relay terminal 107 and the NG-RAN 104.

As will be described in detail below, the UE-to-NE relay terminal 107 decides to switch the communication method for communication between the UE-1 101 and the UE-2 102 as follows. The UE-to-NE relay terminal 107 decides to switch the communication method to one in which communication is performed via the UE-to-UE relay terminal 103 and not via the NG-RAN 104.

As employed herein and in the drawings, the "communication method for communication" may be rephrased as "connection method for communication", "communication method for connection", "connection method for connection", and the like.

### Functional Configuration of Apparatuses

Next, a functional configuration of communication apparatuses according to the embodiment will be described. It should be noted that the configuration of the functional blocks described below is merely exemplary.

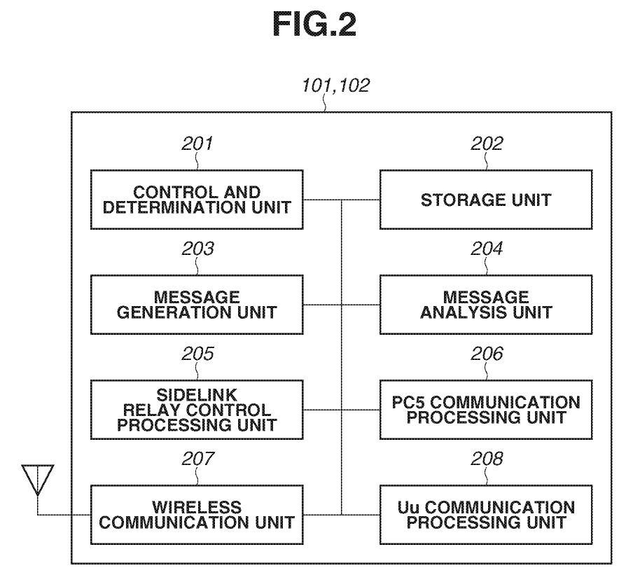

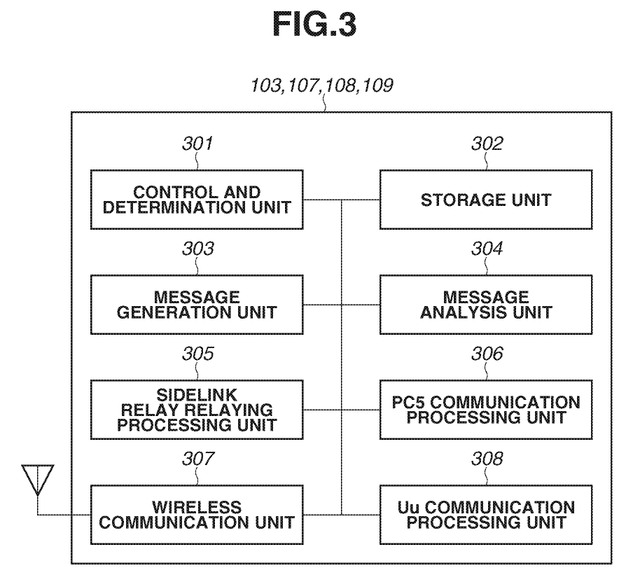

Some (or in some cases, all) of the following functional blocks may be replaced with other functional blocks providing similar functions. Some of the functional blocks may be omitted. Additional functional blocks may be added. One functional block described in the following description may be divided into a plurality of functional blocks. A plurality of functional blocks may be integrated into one functional block. In one embodiment, only some of the functional blocks may be implemented in hardware, and the other functions in software. In the case of implementing functional blocks in software, processors constituting control and determination units 201 and 301 illustrated in FIGS. 2 and 3 to be described below execute control programs for implementing the functions, stored in storage units 202 and 302 to be described below. The functions of the functional blocks are thereby provided.

FIG. 2 is a block diagram illustrating a functional configuration example of the terminal apparatuses (UE-1 101 and UE-2 102) according to the embodiment.

As illustrated in FIG. 2, each of the UE-1 101 and UE-2 102 includes the control and determination unit 201, the storage unit 202, a message generation unit 203, and a message analysis unit 204. Each of the UE-1 101 and UE-2 102 also includes a sidelink relay connection processing unit 205, a PC5 communication processing unit 206, a wireless communication unit 207, and a Uu communication processing unit 208.

The control and determination unit 201 includes, for example, a processor such as a central processing unit (CPU) and a microprocessing unit (MPU), an application-specific integrated circuit (ASIC), a digital signal processor (DSP), or a field-programmable gate array (FPGA). The control and determination unit 201 performs control and determination related to the operation of the UE-1 101 or UE-2 102 by executing programs stored in the storage unit 202, for example. The control and determination unit 201 is an example of a decision unit or decision section, a determination unit or determination section, and the like.

The storage unit 202 includes memories such as a read-only memory (ROM) and a random access memory (RAM), for example. The storage unit 202 stores various types of information, including programs for performing processing to be described below, information that the control and determination unit 201 uses for control and determination, and communication-related information (such as communication parameters for wireless communication). Aside from the memories such as the ROM and RAM, the storage unit 202 may include storage media such a flexible disk, hard disk, optical disc, magnetooptical disc, Compact Disc Read-Only Memory (CD-ROM), Compact Disc Recordable (CD-R), magnetic tape, nonvolatile memory card, and Digital Versatile Disc (DVD).

The message generation unit 203 is constituted by a general-purpose processor such as a CPU (implemented as a program, for example), or a dedicated processing circuit and the like. The message generation unit 203 generates signals, messages, and the like to be transmitted to other UEs and base stations. Such signals, messages, and the like include a response message (illustrated UE-1 [UE-2] Discovery Response message) to a discovery solicitation message. The signals, messages, and the like also include a response message (illustrated Path Switch Response) to a path switch request message. The signals, messages, and the like also include a response message (illustrated Disconnect Response) to a disconnection request message. The signals, messages, and the like also include a response message (illustrated Link Modification Accept) to a connection setting change request message.

The message analysis unit 204 is constituted by a general-purpose processor such as a CPU (implemented as a program, for example), or a dedicated processing circuit and the like. The message analysis unit 204 analyzes signals, messages, and the like received from other UEs and base stations. Such signals, messages, and the like include a discovery solicitation message (illustrated UE-1 (UE-2) Discovery Solicitation message). The signals, messages, and the like also include a discovery announcement message (illustrated UE-to-UE [-NE] Relay Discovery Announsement message). The signals, messages, and the like also include a path switch request message (illustrated Path Switch Request). The signals, messages, and the like also include a disconnection request message (illustrated Disconnect Request) and a connection setting change request message (illustrated Link Modification Request).

The sidelink relay connection processing unit 205 includes hardware for performing wireless communication (compliant with the Third Generation Partnership Project cellular communication standards, for example). The sidelink relay connection processing unit 205 may be constituted by a general-purpose processor such as a CPU (implemented as a program, for example). The sidelink relay connection processing unit 205 performs processing for the UE-1 101 or UE-2 102 to connect to a sidelink relay terminal apparatus.

The PC5 communication processing unit 206 includes hardware for performing wireless communication (compliant with the 3GPP cellular communication standards, for example). The PC5 communication processing unit 206 may be constituted by a general-purpose processor such as a CPU (implemented as a program, for example). The PC5 communication processing unit 206 performs transmission and reception processing when performing PC5 communication (sidelink communication) with other UEs. The PC5 communication processing unit 206 performs processing for transmitting PC5 communication-related messages generated by the message generation unit 203 to other UEs and processing for receiving PC5 communication-related messages from other UEs. The PC5 communication processing unit 206 is an example of a transmission unit or transmission section, a reception unit or reception section, a transmission and reception unit or reception and reception section, a communication unit or communication section, and the like.

The wireless communication unit 207 includes hardware for performing wireless communication (compliant with the 3GPP cellular communication standards, for example). The wireless communication unit 207 may be constituted by a general-purpose processor such as a CPU (implemented as a program, for example). The wireless communication unit 207 performs processing for wireless communication with other UEs and base stations that is common to the transmission and reception processing performed by the PC5 communication processing unit 206 and that by the Uu communication processing unit 208.

The Uu communication processing unit 208 includes hardware for performing wireless communication (compliant with the 3GPP cellular communication standards, for example). The Uu communication processing unit 208 may be constituted by a general-purpose processor such as a CPU (implemented as a program, for example). The Uu communication processing unit 208 performs transmission and reception processing when performing Uu communication with a base station. The Uu communication processing unit 208 performs processing for transmitting Uu communication-related messages generated by the message generation unit 203 to the base station, and processing for receiving Uu communication-related messages from the base station. The Uu communication processing unit 208 is an example of a transmission unit or transmission section, a reception unit or reception section, a transmission and reception unit or transmission and reception section, a communication unit or communication section, and the like.

Any two or more of the sidelink relay connection processing unit 205, the PC5 communication processing unit 206, the wireless communication unit 207, and the Uu communication processing unit 208 may be integrally configured.

FIG. 3 is a block diagram illustrating a functional configuration example of a sidelink relay terminal apparatus (the UE-to-UE relay terminal 103) according to the embodiment.

As illustrated in FIG. 3, the UE-to-UE relay terminal 103 includes the control and determination unit 301, the storage unit 302, a message generation unit 303, and a message analysis unit 304. The UE-to-UE relay terminal 103 also includes a sidelink relay relaying processing unit 305, a PC5 communication processing unit 306, a wireless communication unit 307, and a Uu communication processing unit 308.

The control and determination unit 301 includes, for example, a processor such as a CPU and an MPU, an ASIC, a DSP, an FPGA, or the like. The control and determination unit 301 performs control and determination related to the operation of the UE-to-UE relay terminal 103 by executing programs stored in the storage unit 302, for example. The control and determination unit 301 is an example of a decision unit or decision section, a determination unit or determination section, and the like.

The storage unit 302 includes memories such as a ROM and a RAM, for example. The storage unit 302 stores various types of information, including programs for performing processing to be described below, information for the control and determination unit 301 to use for control and determination, and communication-related information (such as communication parameters for wireless communication). Aside from memories such as the ROM and RAM, the storage unit 302 may include storage media such as a flexible disk, hard disk, optical disc, magnetooptical disc, CD-ROM, CD-R, magnetic tape, nonvolatile memory card, and DVD.

The message generation unit 303 is constituted by a general-purpose processor such as a CPU (implemented as a program, for example), or a dedicated processing circuit and the like. The message generation unit 303 generates signals, messages, and the like to be transmitted to other UEs and base stations. Such signals, messages, and the like include a discovery solicitation message, a response message to a discovery solicitation message, and a discovery announcement message. The signals, messages, and the like also include a path switch request message and a response message to a path switch request message. The signals, messages, and the like also include a disconnection request message, a response message to a disconnection request message, and a connection setting change request message.

The message analysis unit 304 is constituted by a general-purpose processor such as a CPU (implemented as a program, for example), or a dedicated processing circuit and the like. The message analysis unit 304 analyzes signals, messages, and the like received from other UEs and base stations. Such signals, messages, and the like include a discovery solicitation message, a response message to a discovery solicitation message, a path switch request message, and a response message to a path switch request message. The signals, messages, and the like also include a disconnection request message, a response message to a disconnection request message, and a response message to a connection setting change request message.

The sidelink relay relaying processing unit 305 includes hardware for performing wireless communication (compliant with the 3GPP cellular communication standards, for example). The sidelink relay relaying processing unit 305 may be constituted by a general-purpose processor such as a CPU (implemented as a program, for example). The sidelink relay relaying processing unit 305 performs processing for the UE-to-UE relay terminal 103 to connect to the UE-1 101 and the UE-2 102.

The PC5 communication processing unit 306 includes hardware for performing wireless communication (compliant with the 3GPP cellular communication standards, for example). The PC5 communication processing unit 306 may be constituted by a general-purpose processor such as a CPU (implemented as a program, for example). The PC5 communication processing unit 306 performs transmission and reception processing when performing PC5 communication (sidelink communication) with other UEs. The PC5 communication processing unit 306 performs processing for transmitting PC5 communication-related messages generated by the message generation unit 303 to other UEs, and processing for receiving PC5 communication-related messages from other UEs. The PC5 communication processing unit 306 is an example of a transmission unit or transmission section, a reception unit or reception section, a transmission and reception unit or transmission and reception section, a communication unit or communication section, and the like.

The wireless communication unit 307 includes hardware for performing wireless communication (compliant with the 3GPP cellular communication standards, for example). The wireless communication unit 307 may be constituted by a general-purpose processor such as a CPU (implemented as a program, for example). The wireless communication unit 307 performs processing for wireless communication with other UEs and base stations that is common to the transmission and reception processing performed by the PC5 communication processing unit 306 and that by the Uu communication processing unit 308.

The Uu communication processing unit 308 includes hardware for performing wireless communication (compliant with the 3GPP cellular communication standards, for example). The Uu communication processing unit 308 may be constituted by a general-purpose processor such as a CPU (implemented as a program, for example). The Uu communication processing unit 308 performs transmission and reception processing when performing Uu communication with a base station. The Uu communication processing unit 308 performs processing for transmitting Uu communication-related messages generated by the message generation unit 303 to the base station, and processing for receiving Uu communication-related messages from the base station. The Uu communication processing unit 308 is an example of a transmission unit or transmission section, a reception unit or reception section, a transmission and reception unit or transmission and reception section, a communication unit or communication section, and the like.

Any two of the sidelink relay relaying processing unit 305, the PC5 communication processing unit 306, the wireless communication unit 307, and the Uu communication processing unit 308 may be integrally configured.

The functional configuration example of the sidelink relay terminal apparatus (UE-to-UE relay terminal 103) according to the embodiment has been described in detail with reference to FIG. 3. The UE-to-NE relay terminal 107 may have the same or similar functional configuration. A UE-to-NE relay-1 terminal 107, a UE-to-NE relay-2 terminal 108, and a relay UE 109 according to a second or third embodiment to be described below may also have the same or similar functional configuration.

The message generation units 303 of the UE-to-NE relay (relay-1) terminal 107 and the UE-to-NE relay-2 terminal 108 generate signals, messages, and the like to be transmitted to other UEs and base stations. Such signals, messages, and the like include a discovery solicitation message, a response message to a discovery solicitation message, and a discovery announcement message. The signals, messages, and the like also include a path switch request message, and a response message to a path switch request message.

The message analysis units 304 of the UE-to-NE relay (relay-1) terminal 107 and the UE-to-NE relay-2 terminal 108 analyze signals, messages, and the like received from other UEs and base stations. Such signals, messages, and the like include a discovery solicitation message, a response message to a discovery solicitation message, a path switch request message, and a response message to a path switch request message.

The message generation unit 303 of the relay UE 109 generates signals, messages, and the like to be transmitted to other UEs, base stations, and internal functions. Such signals, messages, and the like include a discovery solicitation message, a path switch request message, a disconnection request message, and a connection setting change request message.

The message analysis unit 304 of the relay UE 109 analyzes signals, messages, and the like received from other UEs, base stations, and internal functions. Such signals, messages, and the like include a response message to a discovery solicitation message, a response message to a path switch request message, a response message to a disconnection request message, and a response message to a connection setting change request message.

### Processing Example

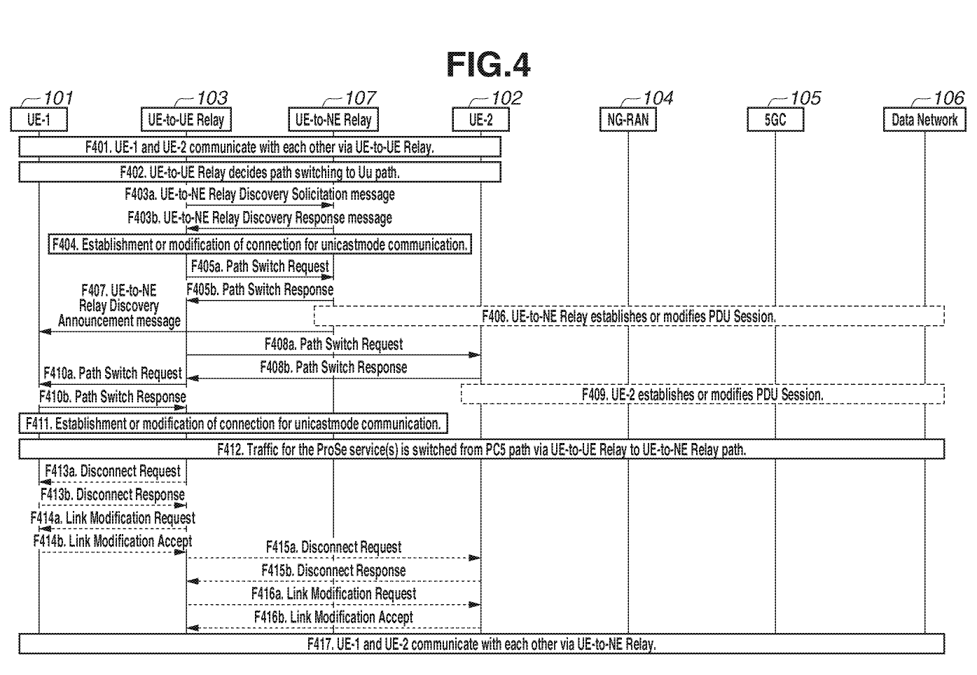

Next, a processing example when the connection between the UE-1 101 and the UE-2 102 is switched from a relay path via the UE-to-UE relay terminal 103 to a Uu path via a base station will be described with reference to the sequence diagram illustrated in FIG. 4.

FIG. 4 is a sequence diagram illustrating a processing example when switching from the relay path via the UE-to-UE relay terminal 103 to a Uu path via the base station, relayed by the UE-to-NE relay terminal 107.

In step F401, the UE-1 101 and the UE-2 102 communicate with each other through the relay path via the UE-to-UE relay terminal 103.

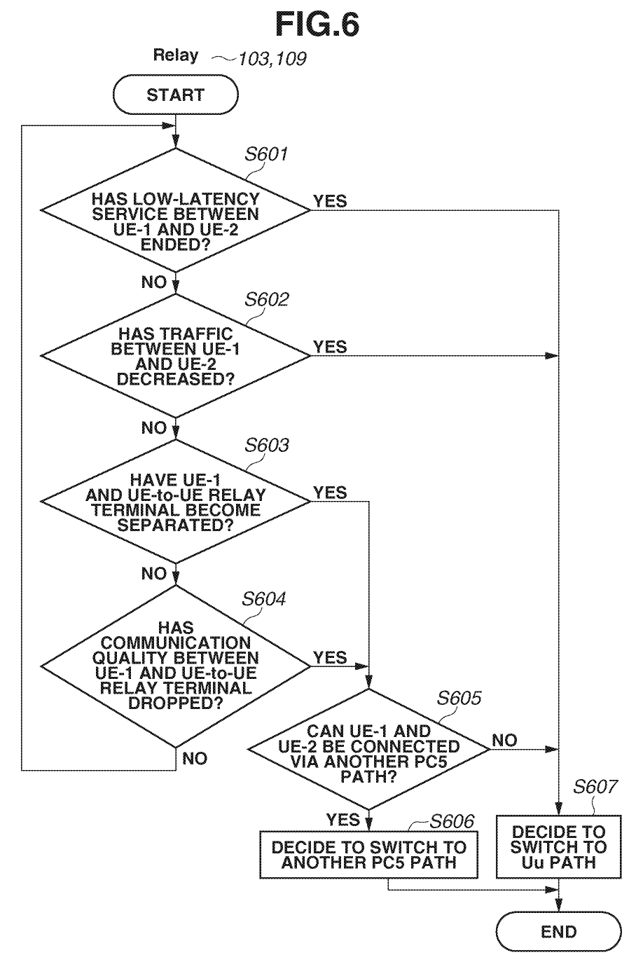

In step F402, the UE-to-UE relay terminal 103 determines the conditions and decides (determines) to switch the communication between the UE-1 101 and the UE-2 102 from the currently used relay path to another path. In this case, the UE-to-UE relay terminal 103 decides (determines) to switch the communication between the UE-1 101 and the UE-2 102 to a Uu path via the base station, relayed by the UE-to-NE relay terminal 107. A detailed processing example (condition determination) of step F402 will be described below with reference to FIG. 6.

To switch from the relay path (PC5 path) to the Uu path via the base station, the UE-to-UE relay terminal 103 initially searches for (discovers) the UE-to-NE relay terminal 107 that relays communication between a terminal and the base station.

For that purpose, in step F403a, the UE-to-UE relay terminal 103 searches for the UE-to-NE relay terminal 107 by transmitting a discovery solicitation message. This discovery solicitation message is an example of a signal related to a relay apparatus (UE-to-NE relay terminal 107) that relays communication of the switched communication method between a first terminal apparatus (UE-1 101) and a second terminal apparatus (UE-2 102). This discovery solicitation message is also an example of a search signal for searching for a relay apparatus (that communicates with the base station).

In step F403b, the UE-to-NE relay terminal 107 receiving the discovery solicitation message transmitted from the UE-to-UE relay terminal 103 operates as follows. The UE-to-NE relay terminal 107 transmits a discovery response message corresponding to the discovery solicitation message to the UE-to-UE relay terminal 103.

In step F404, the UE-to-UE relay terminal 103 and the UE-to-NE relay terminal 107 establish a connection by PC5 communication.

In step F405a, the UE-to-UE relay terminal 103 transmits a path switch request message to the UE-to-NE relay terminal 107. This path switch request message is a message for requesting switching of the communication between the UE-1 101 and the UE-2 102 to the Uu path via the base station, relayed by the UE-to-NE relay terminal 107.

In step F405b, the UE-to-NE relay terminal 107 receiving the path switch request message transmitted from the UE-to-UE relay terminal 103 operates as follows. The UE-to-NE relay terminal 107 transmits a response message (acknowledgment or acceptance message) corresponding to the path switch request message to the UE-to-UE relay terminal 103.

In step F406, the UE-to-NE relay terminal 107 determines the connection status with the base station, and connects to the base station as needed.

In step F407, the UE-to-NE relay terminal 107 notifies other terminals of information about the UE-to-NE 107 by transmitting a discovery announcement message.

In step F408a, the UE-to-UE relay terminal 103 transmits a path switch request message to the UE-2 102. This path switch request message is a message for requesting switching of the communication between the UE-1 101 and the UE-2 102 to the Uu path via the base station, relayed by the UE-to-NE relay terminal 107.

In step F408b, the UE-2 receiving the path switch request message transmitted from the UE-to-UE relay terminal 103 operates as follows. The UE-2 102 transmits a response message (acknowledgement or acceptance message) corresponding to the path switch request message to the UE-to-UE relay terminal 103.

In step F409, the UE-2 102 determines the connection status with the base station, and connects to the base station as needed.

In step F410a, the UE-to-UE relay terminal 103 transmits a path switch request message to the UE-1 101. This path switch request message is a message for requesting switching of the communication between the UE-1 101 and the UE-2 102 to the Uu path via the base station, relayed by the UE-to-NE relay terminal 107.

In step F410b, the UE-1 101 receiving the path switch request message transmitted from the UE-to-UE relay terminal 103 operates as follows. The UE-1 101 transmits a response message (acknowledgement or acceptance message) corresponding to the path switch request message to the UE-to-UE relay terminal 103.

In step F411, the UE-1 101 and the UE-to-NE relay terminal 107 establish a connection by PC5 communication.

With the UE-2 102 and the UE-to-NE relay terminal 107 both connected to the base station, in step F412, the UE-1 101 and the UE-2 102 operate as follows. The UE-1 101 and the UE-2 102 switch the communication path between the UE-1 101 and the UE-2 102 from the relay path (PC5 path) via the UE-to-UE relay terminal 103 to the Uu path. This Uu path is the path via the base station, relayed by the UE-to-NE relay terminal 107.

In step F413a, the UE-to-UE relay terminal 103 transmits a disconnection request message for requesting disconnecting the connection or communication with the UE-1 101 to the UE-1 101 as needed. In step F413b, the UE-1 101 transmits a response massage (acknowledgement or acceptance message) corresponding to the disconnection request message to the UE-to-UE relay terminal 103 as needed.

In step F414a, the UE-to-UE relay terminal 103 transmits a connection setting change request message for requesting a change in the connection setting with the UE-1 101 to the UE-1 101 as needed. In step F414b, the UE-1 101 transmits a response message (acknowledgment or acceptance message) corresponding to the connection setting change request massage to the UE-to-UE relay terminal 103 as needed.

In step F415a, the UE-to-UE relay terminal 103 transmits a disconnection request message for requesting disconnecting the connection or communication with the UE-2 102 to the UE-2 102 as needed. In step F415b, the UE-2 102 transmits a response message (acknowledgment or acceptance message) corresponding to the disconnection request message to the UE-to-UE relay terminal 103 as needed.

In step F416a, the UE-to-UE relay terminal 103 transmits a connection setting change request message for requesting a change in the connection setting with the UE-2 102 to the UE-2 102 as needed. In step F416b, the UE-2 102 transits a response message (acknowledgment or acceptance message) corresponding to the connection setting change request message to the UE-to-UE relay terminal 103 as needed.

In step F417, the UE-1 101 and the UE-2 102 communicate with each other through the Uu path via the base station, relayed by the UE-to-NE relay terminal 107.

FIG. 6 is a flowchart illustrating a processing example when the UE-to-UE relay terminal 103 determines to switch from the relay path that the UE-to-UE relay terminal 103 relays to another PC5 path or Uu path in step F402 of the sequence diagram illustrated in FIG. 4.

In step S601, the UE-to-UE relay terminal 103 determines whether a low-latency service (or application) being executed between the UE-1 101 and the UE-2 102 has ended (the operating state or execution state of the low-latency service). Examples of the low-latency service include a Ultra-Reliable and Low Latency Communications (URLLC) service.

If the UE-to-UE relay terminal 103 determines that the low-latency service has ended (YES in step S601), the processing proceeds to step S607. On the other hand, if the UE-to-UE relay terminal 103 determines that the low-latency service has not ended (NO in step S601), the processing proceeds to step S602.

In step S602, the UE-to-UE relay terminal 103 determines whether the traffic being transmitted and received between the UE-1 101 and the UE-2 has decreased sufficiently for a Uu path (for example, to or below a threshold).

If the UE-to-UE relay terminal 103 determines that the traffic has decreased (YES in step S602), the processing proceeds to step S607. On the other hand, if the UE-to-UE relay terminal 103 determines that the traffic has not decreased (NO in step S602), the processing proceeds to step S603.

In step S603, the UE-to-UE relay terminal 103 determines whether the UE-1 101 and the UE-to-UE relay terminal 103 have become separated by a distance at which PC5 connection is unavailable. This determination is made based on positional information about the UE-1 101 and the UE-to-UE relay terminal 103. Such a determination may additionally or alternatively be made based on communication quality information (such as received power, received signal-to-noise ratio [SNR], and received error rate) or the like about the UE-1 101 and the UE-to-UE relay terminal 103.

If the UE-to-UE relay terminal 103 determines that the UE-1 101 and the UE-to-UE relay terminal 103 become separated (YES in step S603), the processing proceeds to step S605. On the other hand, if the UE-to-UE relay terminal 103 determines that the UE-1 101 and the UE-to-UE relay terminal 103 have not become separated (NO in step S603), the processing proceeds to step S604.

In step S604, the UE-to-UE relay terminal 103 determines whether the communication quality between the UE-1 101 and the UE-to-UE relay terminal 103 has dropped (for example, to or below a threshold). Examples of the communication quality may include reference signal received power (RSRP) (such as sidelink discovery RSRP [SD-RSRP] and sidelink RSRP [SL-RSRP]), a received signal strength indicator (RSSI), and a reference signal received quality (RSRQ). The communication quality may be rephrased as signal strength. That the communication quality between communication apparatuses is favorable (high) means that the communication conditions between the communication apparatuses are favorable.

If the UE-to-UE relay terminal 103 determines that the communication quality has dropped (YES in step S604), the processing proceeds to step S605. On the other hand, if the UE-to-UE relay terminal 103 determines that the communication quality has not dropped (NO in step S604), the processing returns to step S601.

In step S605, the UE-to-UE relay terminal 103 determines whether the UE-1 101 and the UE-2 102 can be connected via another PC5 path. Examples of another PC5 path include other relay paths via alternative UE-to-UE relay terminals other than the UE-to-UE relay terminal 103 connecting the UEs via the current relay path, and a direct PC5 path.

If the UE-to-UE relay terminal 103 determines that the UE-1 101 and the UE-2 102 can be connected via another PC5 path (YES in step S605), the processing proceeds to step S606. On the other hand, if the UE-to-UE relay terminal 103 determines that the UE-1 101 and the UE-2 102 are unable to be connected via another PC5 path (NO in step S605), the processing proceeds to step S607.

In step S606, the UE-to-UE relay terminal 103 decides which to use among other relay paths and a direct PC5 path (switch to another PC5 path). The procedure ends.

For example, in step S606, the UE-to-UE relay terminal 103 may select or decide the switched path in the following manner.

The UE-to-UE relay terminal 103 acquires a first communication quality of a direct PC5 connection path between the UE-1 101 and the UE-2 102. The UE-to-UE relay terminal 103 also acquires a second communication quality of a path from the UE-1 101 to the UE-2 102 via an alternative UE-to-UE relay terminal. Based on the first communication quality and the second communication quality, the UE-to-UE relay terminal 103 operates as follows. The UE-to-UE relay terminal 103, based on these communication qualities, selects the path to connect the UE-1 101 and the UE-2 102 from between the direct PC5 connection path and the path via the alternative UE-to-UE relay terminal. There may be more than one alternative UE-to-UE relay terminal (candidate relay apparatus). In such a case, there are multiple second communication qualities corresponding to the respective alternative UE-to-UE relay terminals (candidate relay apparatuses). Here, the communication quality of a path may refer to the entirety of the communication qualities between respective connected communication apparatuses (UEs and UE-to-UE relay terminals) included in the path. Selecting the path to connect the UE-1 101 and the UE-2 102 based on the path communication quality may include provisionally selecting paths where all the respective communication qualities fall within a predetermined range (for example, higher than or equal to a threshold). The selecting then may include selecting as the path to connect the UE-1 101 and the UE-2 102 a path with the most favorable communication quality within the predetermined range among the one or more provisionally selected paths.

In step S607, the UE-1 101 decides to switch from the relay path to a Uu path, based on the determination result (YES) in either of steps S601 and S602 or the determination result (NO) of step S605. The procedure ends.

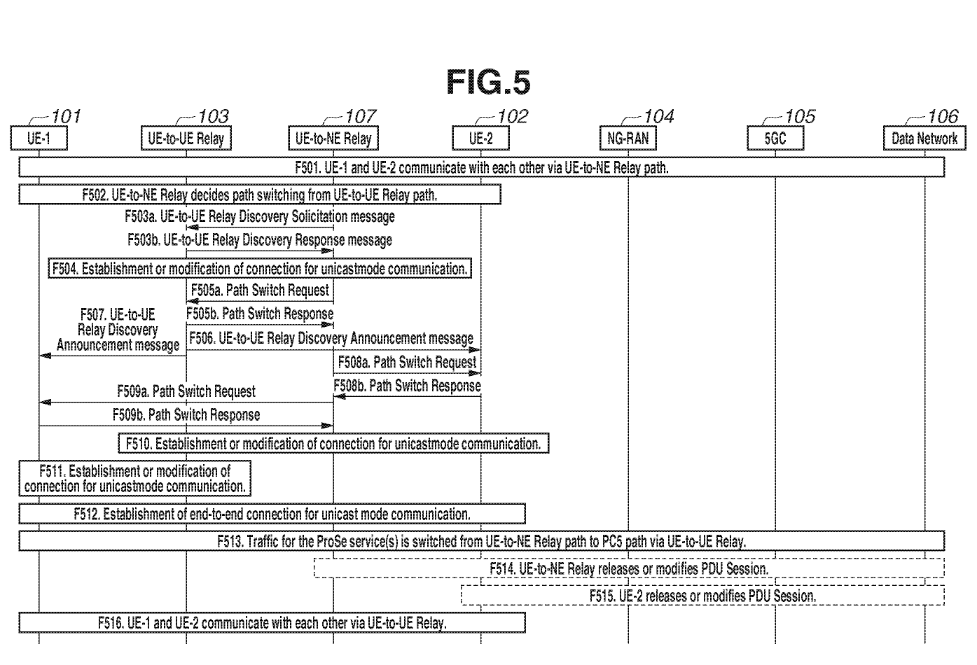

Next, a processing example when the communication between the UE-1 101 and the UE-2 102 is switched from the Uu path via the base station to a relay path via the UE-to-UE relay path 103 will be described with reference to the sequence diagram illustrated in FIG. 5.

FIG. 5 is a sequence diagram illustrating the processing example when switching from the relay path via the base station, relayed by the UE-to-NE relay terminal 107, to a relay path via the UE-to-UE relay terminal 103.

The sequence diagram of FIG. 5 illustrates an example of a case where the UE-to-NE relay terminal 107 searches for a UE-to-UE relay terminal to be used for the relay path, using a discovery solicitation message issued by the UE-to-NE relay terminal 107. This case corresponds to Model B. The sequence diagram of FIG. 5 also illustrates an example of a case where the UE-1 101 and the UE-2 102 discover the UE-to-UE relay terminal 103 to be used for the relay path, using a discovery announcement message issued by the UE-to-UE relay terminal 103. This case corresponds to Model A.

In step F501, the UE-1 101 and the UE-2 102 communicate with each other through a Uu path via the base station. The UE-1 101 is connected to the base station (for example, NG-RAN 104) via relaying by the UE-to-NE relay terminal 107.

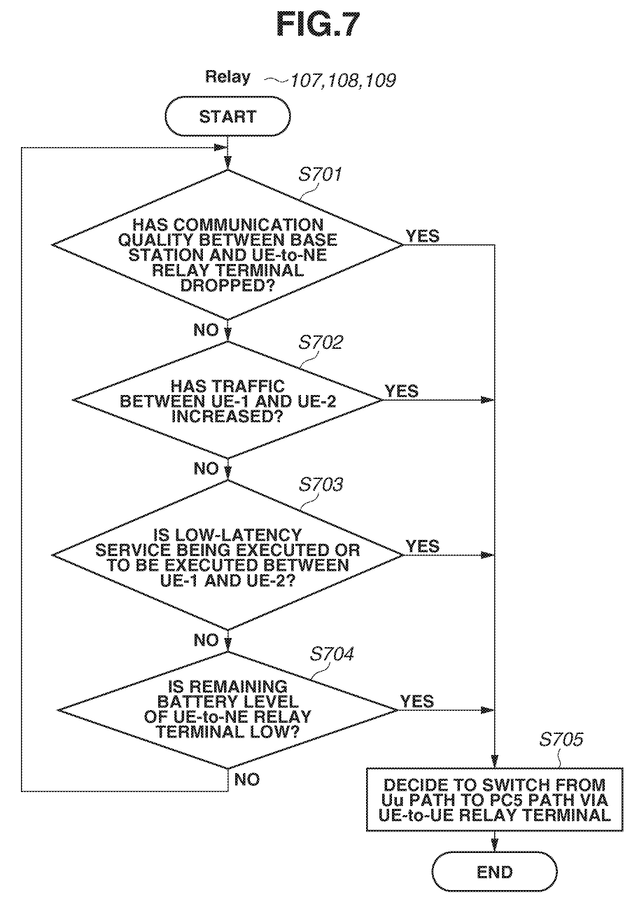

In step F502, the UE-to-NE relay terminal 107 determines the conditions and decides (determines) to switch the communication between the UE-1 101 and the UE-2 102 from the currently used Uu path to another path. In this example, the UE-to-NE relay terminal 107 decides (determines) to switch the communication between the UE-1 101 and the UE-2 102 to a relay path via the UE-to-UE relay terminal 103. A detailed processing example (condition determination) of step F502 will be described below with reference to FIG. 7.

In step F503a, the UE-to-NE relay terminal 107 searches for (discovers) the UE-to-UE relay terminal 103 by transmitting a discovery solicitation message by PC5 communication. This discovery solicitation message is an example of a signal related to a relay apparatus (UE-to-UE relay terminal 103) that relays communication of the switched communication method between the first terminal apparatus (UE-1 101) and the second terminal apparatus (UE-2 102). The discovery solicitation message is also an example of a search signal for searching for a relay apparatus (that does not communicate with the base station).

In step F503b, the UE-to-UE relay terminal 103 receiving the discovery solicitation message transmitted from the UE-to-NE relay terminal 107 transmits a response message to the discovery solicitation message.

In step F504, the UE-to-NE relay terminal 107 performs connection processing with the UE-to-UE relay terminal 103 discovered by the search.

In step F505a, the UE-to-NE relay terminal 107 transmits to the UE-to-UE relay terminal 103 a path switch request message for requesting switching from the Uu path to the PC5 path. In step F505b, the UE-to-UE relay terminal 103 receiving the path switch request message transmitted from the UE-to-NE relay terminal 107 operates as follows. The UE-to-UE relay transmission 103 transmits a response message (acknowledgment or acceptance message) corresponding to the path switch request message to the UE-to-NE relay terminal 107.

The UE-to-UE relay terminal 103 recognizes from the path switch request message transmitted in step F505a that the communication between the UE-1 101 and the UE-2 102 is to be switched from the Uu path to the relay path.

In steps F506 and F507, the UE-to-UE relay terminal 103 transmits a discovery announcement message to the UE-1 101 and the UE-2 102, respectively. The UE-1 101 and the UE-2 102 can recognize from the discovery announcement message the presence of the UE-to-UE relay terminal 103, and use the recognition in determining whether to switch to the relay path.

In step F508a, the UE-to-NE relay terminal 107 transmits to the UE-2 102 a path switch request message for requesting switching from the Uu path to the PC5 path. In step F508b, the UE-2 102 receiving the path switch request message transmitted from the UE-to-NE relay terminal 107 operates as follows. The UE-2 102 transmits a response message (acknowledgment or acceptance message) corresponding to the path switch request message to the UE-to-NE relay terminal 107.

In step F509a, the UE-to-NE relay terminal 107 transmits to the UE-1 101 a path switch request message for requesting switching from the Uu path to the PC5 path. In step F509b, the UE-1 101 receiving the path switch request message transmitted from the UE-to-NE relay terminal 107 operates as follows. The UE-1 101 transmits a response message (acknowledgment or acceptance message) corresponding to the path switch request message to the UE-to-NE relay terminal 107.

In step F510, the UE-to-UE relay terminal 103 performs connection processing with the UE-2 102.

In step F511, the UE-1 101 performs connection processing with the UE-to-UE relay terminal 103 discovered by the search.

In step F512, the UE-1 101 performs connection processing with the UE-2 102 via the UE-to-UE relay terminal 103.

In step F513, the UE-1 101 and the UE-2 102 switch the previous transmission and reception of information through the Uu path via the base station, relayed by the UE-to-NE relay terminal 107, to transmission and reception via the relay path. This relay path is the path via the UE-to-UE relay terminal 103.

After the switching to the relay path, in step F514, the UE-to-NE relay terminal 107 operates as follows. The UE-to-NE relay terminal 107 determines whether the communication via the base station is being used by other applications or the like. If the connection with the base station is determined to not be needed, the UE-to-NE relay terminal 107 releases (or disconnects) the connection.

After the switching to the relay path, in step F515, the UE-2 102 determines whether the communication via the base station is being used by other applications or the like. If the connection with the base station is determined to not be needed, the UE-2 102 releases (or disconnects) the connection.

In step F516, the UE-1 101 and the UE-2 102 communicate with each other through the relay path via the UE-to-UE relay terminal 103.

FIG. 7 is a flowchart illustrating a processing example when the UE-to-NE relay terminal 107 determines whether to switch from the Uu path to a relay path in step F502 in the sequence diagram illustrated in FIG. 5.

In step S701, the UE-to-NE relay terminal 107 determines whether the communication quality between the base station currently connected to form the Uu path and the UE-to-NE relay terminal 107 has dropped (for example, to or below a threshold). Examples of the communication quality may include RSRP (such as SD-RSRP and SL-RSRP), RSSI, and RSRQ. That the communication quality between communication apparatuses is favorable (high) means that the communication conditions between the communication apparatuses are favorable.

If the UE-to-NE relay terminal 107 determines that the communication quality has dropped (YES in step S701), the processing proceeds to step S705. On the other hand, if the UE-to-NE relay terminal 107 determines that the communication quality has not dropped (NO in step S701), the processing proceeds to step S702.

In step S702, the UE-to-NE relay terminal 107 determines whether the traffic being transmitted and received between the UE-1 101 and the UE-2 102 via the Uu path has increased (for example, to or above a threshold). Alternatively, in step S702, the UE-to-NE relay terminal 107 determines whether the foregoing traffic is predicted to increase (for example, to or above a threshold within a predetermined time or at a predetermined time).

If the UE-to-NE relay terminal 107 determines whether the traffic has increased or is predicted to increase (YES in step S702), the processing proceeds to step S705. On the other hand, if the UE-to-NE relay terminal 107 determines that the traffic has not increased or is not predicted to increase (is predicted to not increase) (NO in step S702), the processing proceeds to step S703.

In step S703, the UE-to-NE relay terminal 107 determines whether a low-latency service is being executed or to be executed between the UE-1 101 and the UE-2 102. In other words, the UE-to-NE relay terminal 107 determines the operating state or execution state of a low-latency service being executed or to be executed between the UE-1 101 and the UE-2 102.

If the UE-to-NE relay terminal 107 determines that a low-latency service is being executed or to be executed (YES in step S703), the processing proceeds to step S705. On the other hand, if the UE-to-NE relay terminal 107 determines that no low-latency service is being executed or to be executed (NO in step S703), the processing proceeds to step S704.

In step S704, the UE-to-NE relay terminal 107 determines whether the remaining battery level of the UE-to-NE relay terminal 107 is low (for example, lower than or equal to a threshold). In other words, the UE-to-NE relay terminal 107 determines whether the remaining battery level is sufficient to continue the communication through the Uu path via the base station.

If the UE-to-NE relay terminal 107 determines that the remaining battery level is low (YES in step S704), the processing proceeds to step S705. On the other hand, if the UE-to-NE relay terminal 107 determines that the remaining battery level is not low (NO in step S704), the processing returns to step S701.

In step S705, based on the determination result ("YES") of any of steps S701 to S704, the UE-to-NE relay terminal 107 decides to switch from the Uu path to a relay path (PC5 path) via the UE-to-UE relay terminal 103. The procedure then ends.

As described above, according to the embodiment, the communication between the UEs can be switched between communication via a base station (communication via a Uu path) and communication not via a base station but via a relay UE (communication through a PC5 path via a relay). This can expand, for example, the coverage of high-speed low-power-consumption direct communication between UEs in proximity. Communication between terminal apparatuses where a relay apparatus may intervene can thereby be appropriately switched between communication via a base station and communication not via a base station.

### Second Embodiment

The first embodiment has dealt with path switching in a communication system including one UE-to-NE relay terminal. A second embodiment deals with path switching in a communication system including two UE-to-NE relay terminals. Note that where configurations and processes in the second embodiment are the same as or similar to those in the first embodiment, a description thereof may be omitted.

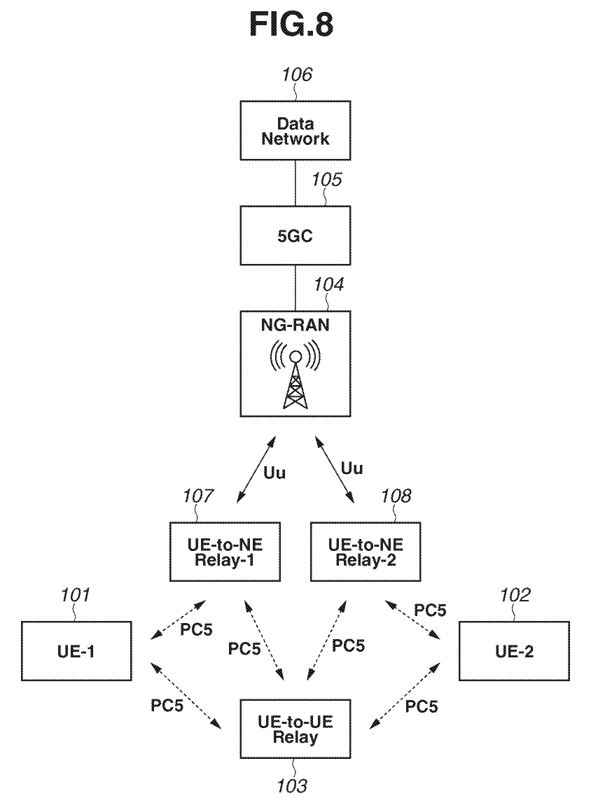

FIG. 8 is a diagram illustrating a configuration example of the communication system according to the second embodiment of the disclosure. The communication system illustrated in FIG. 8 has the configuration of the communication system illustrated in FIG. 1 with a UE-to-NE relay-2 terminal 108 added thereto. In FIG. 8, the UE-to-NE relay terminal 107 in FIG. 1 is referred to as a UE-to-NE relay-1 terminal 107. In the example illustrated in FIG. 8, the UE-to-NE relay-2 terminal 108 relays and connects the communication of a UE-2 102 to a base station.

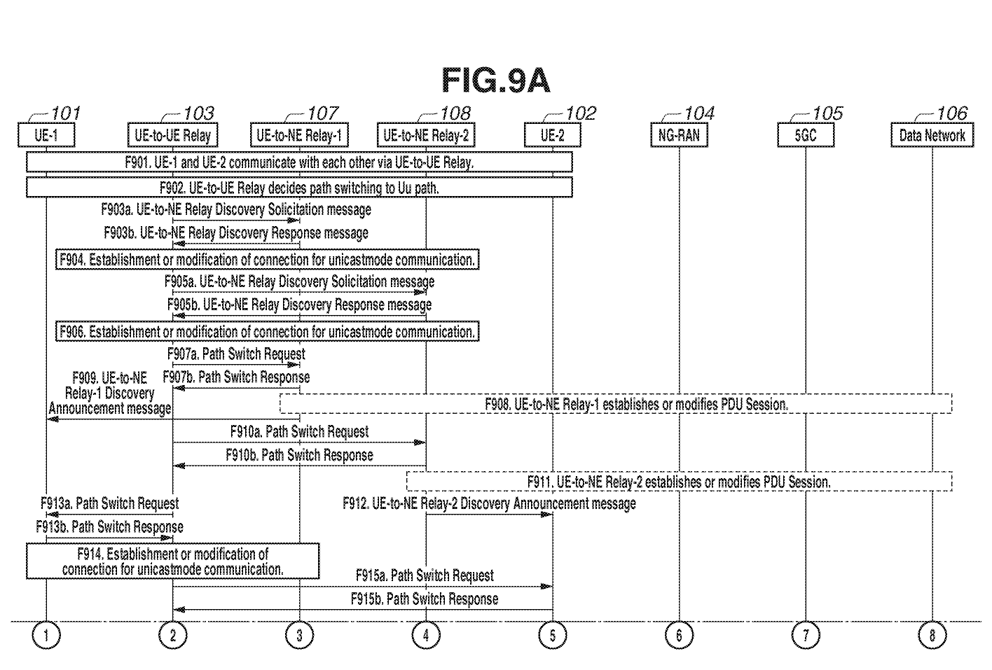

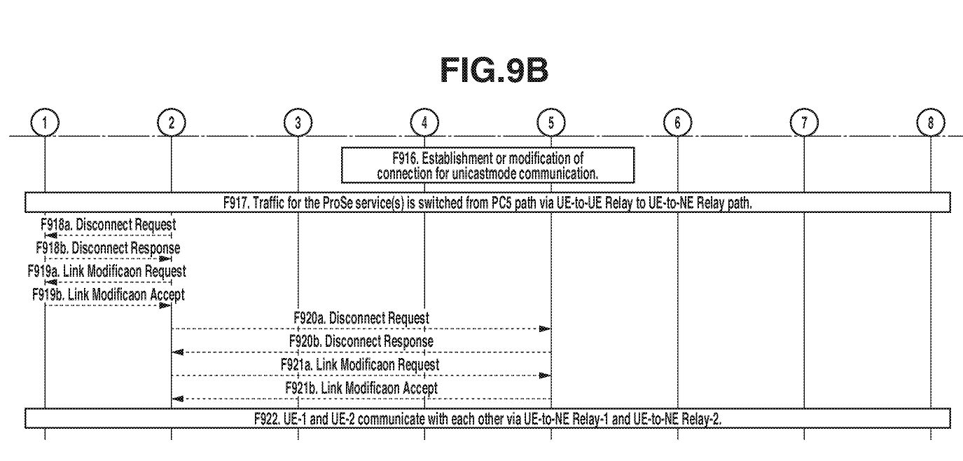

As the second embodiment, a processing example when communication between a UE-1 101 and the UE-2 102 is switched from a relay path via a UE-to-UE relay terminal 103 to a Uu path via the base station will be described with reference to the sequence diagram illustrated in FIGS. 9A and 9B. This Uu path is a path via the base station, relayed by the two UE-to-NE relay terminals 107 and 108.

FIGS. 9A and 9B are sequence diagrams illustrating the processing example when switching from the relay path via the UE-to-UE relay terminal 103 to the Uu path via the base station, relayed by the UE-to-NE relay-1 terminal 107 and relay-2 terminal 108.

In step F901, the UE-1 101 and the UE-2 102 communicate with each other through the relay path via the UE-to-UE relay terminal 103.

In step F902, the UE-to-UE relay terminal 103 determines the conditions and decides (determines) to switch the communication between the UE-1 101 and the UE-2 102 from the currently used relay path to another path. In this example, the UE-to-UE relay terminal 103 decides (determines) to switch the communication between the UE-1 101 and the UE-2 102 to a Uu path via the base station, relayed by the UE-to-NE relay-1 terminal 107 and relay-2 terminal 108. A detailed processing example (condition determination) of step F902 is similar to that described above with reference to FIG. 6, and a description thereof will thus be omitted.

To switch from the relay path (PC5 path) to the Uu path via the base station, the UE-to-UE relay terminal 103 initially operates as follows. The UE-to-UE relay terminal 103 searches for (discovers) the UE-to-NE relay-1 terminal 107 and the UE-to-NE relay-2 terminal 108 that relay communication between terminals and the base station.

For that purpose, in step F903a, the UE-to-UE relay terminal 103 transmits a discovery solicitation message to the UE-to-NE relay-1 terminal 107. This discovery solicitation message is an example of a signal related to a relay apparatus (UE-to-NE relay-1 term 107) that relays communication of the switched communication method between a first terminal apparatus (UE-1 101) and a second terminal apparatus (UE-2 102).

This discovery solicitation message is also an example of a search signal for searching for a relay apparatus (that communicates with the base station).

In step F903b, the UE-to-NE relay-1 terminal 107 receiving the discovery solicitation message transmitted from the UE-to-UE relay terminal 103 operates as follows. The UE-to-NE relay-1 terminal 107 transmits a discovery response message corresponding to the discovery solicitation message to the UE-to-UE relay terminal 103.

In step F904, the UE-to-UE relay terminal 103 and the UE-to-NE relay-1 terminal 107 establish a connection by PC5 communication.

In step F905a, the UE-to-UE relay terminal 103 transmits a discovery solicitation message to the UE-to-NE relay-2 terminal 108. This discovery solicitation message is an example of a signal related to a relay apparatus (UE-to-NE relay-2 terminal 108) that relays communication of the switched communication method between the first terminal (UE-1 101) and the second terminal (UE-2 102). This discovery solicitation message is also an example of the search signal for searching for a relay apparatus (that communicates with the base station).

In step F905b, the UE-to-NE relay-2 terminal 108 receiving the discovery solicitation message transmitted from the UE-to-UE relay terminal 103 operates as follows. The UE-to-NE relay-2 terminal 108 transmits a discovery response message corresponding to the discovery solicitation message to the UE-to-UE relay terminal 103.

In step F906, the UE-to-UE relay terminal 103 and the UE-to-NE relay-2 terminal 108 establish a connection by PC5 communication.

In step F907a, the UE-to-UE relay terminal 103 transmits a path switch request message to the UE-to-NE relay-1 terminal 107. This path switch request message is a message for requesting switching of the communication between the UE-1 101 and the UE-2 102 to the Uu path via the base station, relay by the UE-to-NE relay-1 terminal 107 and relay-2 terminal 108.

In step F907b, the UE-to-Ne relay-1 terminal 107 receiving the path switch request message transmitted from the UE-to-UE relay terminal 103 operates as follows. The UE-to-NE relay-1 terminal 107 transmits a response message (acknowledgement or acceptance message) corresponding to the path switch request message to the UE-to-UE relay terminal 103.

In step F908, the UE-to-NE relay-1 terminal 107 determines the connection status with the base station, and connects to the base station as needed.

In step F909, the UE-to-NE relay-1 terminal 107 notifies another terminal of information about the UE-to-NE relay-1 terminal 107 by transmitting a discovery announcement message. Another terminal here refers to the UE-1 101.

In step F910a, the UE-to-UE relay terminal 103 transmits a path switch request message to the UE-to-NE relay-2 terminal 108. This path switch request message is a message for requesting switching of the communication between the UE-1 101 and the UE-2 102 to the Uu path via the base station, relayed by the UE-to-NE relay-1 terminal 107 and relay-2 terminal 108.

In step F910b, the UE-to-NE relay-2 terminal 108 receiving the path switch request message transmitted from the UE-to-UE relay terminal 103 operates as follows. The UE-to-NE relay-2 terminal 108 transmits a response message (acknowledgment or acceptance message) corresponding to the path switch request message to the UE-to-UE relay terminal 103.

In step F911, the UE-to-NE relay-2 terminal 108 determines the connection status with the base station, and connects to the base station as needed.

In step F912, the UE-to-NE relay-2 terminal 108 notifies another terminal of information about the UE-to-NE relay-2 terminal 108 by transmitting a discovery announcement message. Another terminal here refers to the UE-2 102.

In step F913a, the UE-to-UE relay terminal 103 transmits a path switch request message to the UE-1 101. This path switch request message is a message for requesting switching of the communication between the UE-1 101 and the UE-2 102 to the Uu path via the base station, relayed by the UE-to-NE relay-1 terminal 107 and relay-2 terminal 108.

In step F913b, the UE-1 101 receiving the path switch request message transmitted from the UE-to-UE relay terminal 103 operates as follows. The UE-1 101 transmits a response message (acknowledgment or acceptance message) corresponding to the path switch request message to the UE-to-UE relay terminal 103.

In step F914, the UE-1 101 and the UE-to-NE relay-1 terminal 107 establish a connection by PC5 communication.

In step F915a, the UE-to-UE relay terminal 103 transmits a path switch request message to the UE-2 102. This path switch request message is a message for requesting switching of the communication between the UE-1 101 and the UE-2 102 to the Uu path via the base station, relayed by the UE-to-NE relay-1 terminal 107 and relay-2 terminal 108.

In step F915b, the UE-2 102 receiving the path switch request message transmitted from the UE-to-UE relay terminal 103 operates as follows. The UE-2 102 transmits a response message (acknowledgment or acceptance message) corresponding to the path switch request message to the UE-to-UE relay terminal 103.

In step F916, the UE-2 102 and the UE-to-NE relay-2 terminal 108 establish a connection by PC5 communication.

With the UE-to-NE relay-1 terminal 107 and the UE-to-NE relay-2 terminal 108 both connected to the base station, in step F917, the UE-1 101 and the UE-2 102 operate as follows. The UE-1 101 and the UE-2 102 switch the communication path between the UE-1 101 and the UE-2 102 from the relay path (PC5 path) via the UE-to-UE relay terminal 103 to the Uu path. This Uu path is the path via the base station, relayed by the UE-to-NE relay-1 terminal 107 and the UE-to-NE relay-2 terminal 108.

In step F918a, the UE-to-UE relay terminal 103 transmits a disconnection request message for requesting disconnecting the connection or communication with the UE-1 101 to the UE-1 101 as needed. In step F918b, the UE-1 101 transmits a response message (acknowledgment or acceptance message) corresponding to the disconnection request message to the UE-to-UE relay terminal 103 as needed.

In step F919a, the UE-to-UE relay terminal 103 transmits a connection setting change request message for requesting a change in the connection setting with the UE-1 101 to the UE-1 101 as needed. In step F919b, the UE-1 101 transmits a response message (acknowledgment or acceptance message) corresponding to the connection setting change request message to the UE-to-UE relay terminal 103 as needed.

In step F920a, the UE-to-UE relay terminal 103 transmits a disconnection request message for requesting disconnecting the connection or communication with the UE-2 102 to the UE-2 102 as needed. In step F920b, the UE-2 102 transmits a response message (acknowledgment or acceptance message) corresponding to the disconnection request message to the UE-to-UE relay terminal 103 as needed.

In step F921a, the UE-to-UE relay terminal 103 transmits a connection setting change request message for requesting a change in the connection setting with the UE-2 102 to the UE-2 102 as needed. In step F921b, the UE-2 102 transmits a response message (acknowledgment or acceptance message) corresponding to the connection setting change request message to the UE-to-UE relay terminal 103 as needed.

In step F922, the UE-1 101 and the UE-2 102 communicate with each other through the Uu path via the base station, relayed by the UE-to-NE relay-1 terminal 107 and the UE-to-NE relay-2 terminal 108.

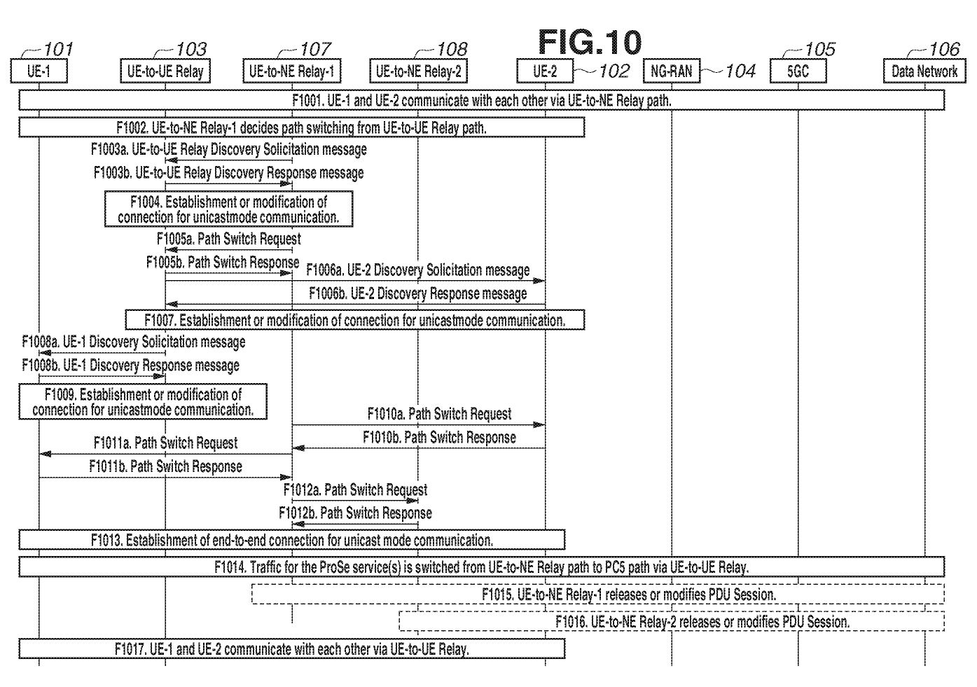

Next, a processing example when the communication between the UE-1 101 and the UE-2 102 is switched from the Uu path via the base station to a relay path via the UE-to-UE relay terminal 103 will be described with reference to the sequence diagram illustrated in FIG. 10.

FIG. 10 is a sequence diagram illustrating the processing example when switching from the Uu path via the base station, relayed by the UE-to-NE relay-1 terminal 107 and relay-2 terminal 108, to a relay path via the UE-to-UE relay terminal 103.

In step F1001, the UE-1 101 and the UE-2 102 communicate with each other through the Uu path via the base station. The UE-1 101 is connected to the base station (for example, NG-RAN 104) via relaying by the UE-to-NE relay-1 terminal 107. The UE-2 102 is connected to the base station (for example, NG-RAN 104) via relaying by the UE-to-NE relay-2 terminal 108.

In step F1002, the UE-to-NE relay-1 terminal 107 determines the conditions and decides (determines) to switch the communication between the UE-1 101 and the UE-2 102 from the currently used Uu path to another path. In this example, the UE-to-NE relay-1 terminal 107 decides (determines) to switch the communication between the UE-1 101 and the UE-2 102 to a relay path via the UE-to-UE relay terminal 103. A detailed processing example (condition determination) of step F1002 is similar to that described above with reference to FIG. 7, and a description thereof will thus be omitted.

In step F1003a, the UE-to-NE relay-1 terminal 107 searches for (discovers) the UE-to-UE relay terminal 103 by transmitting a discovery solicitation message by PC5 communication. This discovery solicitation message is an example of a signal related to a relay apparatus (UE-to-UE relay terminal 103) that relays communication of the switched communication method between the first terminal apparatus (UE-1 101) and the second terminal apparatus (UE-2 102). This discovery solicitation message is also an example of a search signal for searching for a relay apparatus (that does not communicate with the base station).

In step F1003b, the UE-to-UE relay terminal 103 receiving the discovery solicitation message transmitted from the UE-to-NE relay-1 terminal 107 transmits a response message to the discovery solicitation message.

In step F1004, the UE-to-NE relay-1 terminal 107 performs connection processing with the UE-to-UE relay terminal 103 discovered by the search.

In step F1005a, the UE-to-NE relay-1 terminal 107 transmits to the UE-to-UE relay terminal 103 the path switch request message for requesting switching from the Uu path to a PC5 path. In step F1005b, the UE-to-UE relay terminal 103 receiving the path switch request message transmitted from the UE-to-NE relay-1 terminal 107 operates as follows. The UE-to-UE relay terminal 103 transmits a response message (acknowledgment or acceptance message) corresponding to the path switch request message to the UE-to-NE relay-1 terminal 107. Th UE-to-UE relay terminal 103 recognizes from the path switch request message transmitted in step F1005a that the communication between the UE-1 101 and the UE-2 102 is to be switched from the Uu path to the relay path.

In step F1006a, the UE-to-UE relay terminal 103 transmits a discovery solicitation message to the UE-2 102.

In step F1006b, the UE-2 102 receiving the discovery solicitation message transmitted from the UE-to-UE relay terminal 103 operates as follows. The UE-2 102 transmits a discovery response message corresponding to the discovery solicitation message to the UE-to-UE relay terminal 103.

In step F1007, the UE-to-UE relay terminal 103 performs connection processing with the UE-2 102 discovered by the search.

In step F1008a, the UE-to-UE relay terminal 103 transmits a discovery solicitation message to the UE-1 101.

In step F1008b, the UE-1 101 receiving the discovery solicitation message transmitted from the UE-to-UE relay terminal 103 operates as follows. The UE-1 101 transmits a discovery response message corresponding to the discovery solicitation message to the UE-to-UE relay terminal 103.

In step F1009, the UE-to-UE relay terminal 103 performs connection processing with the UE-1 101 discovered by the search.

In step F1010a, the UE-to-NE relay-1 terminal 107 transmits to the UE-2 102 a path switch request message for requesting switching from the Uu path to the PC5 path. In step F1010b, the UE-2 102 receiving the path switch request message transmitted from the UE-to-NE relay-1 terminal 107 operates as follows. The UE-2 102 transmits a response message (acknowledgment or acceptance message) corresponding to the path switch request message to the UE-to-NE relay-1 terminal 107.

In step F1011a, the UE-to-NE relay-1 terminal 107 transmits to the UE-1 101 a path switch request message for requesting switching from the Uu path to the PC5 path. In step F1011b, the UE-1 101 receiving the path switch request message transmitted from the UE-to-NE relay-1 terminal operates as follows. The UE-1 101 transmits a response message (acknowledgment or acceptance message) corresponding to the path switch request message to the UE-to-NE relay-1 terminal 107.

In step F1012a, the UE-to-NE relay-1 terminal 107 transmits to the UE-to-NE relay-2 terminal 108 a path switch request message for requesting switching of the Uu path to the PC5 path. In step F1012b, the UE-to-NE relay-2 terminal 108 receiving the path switch request message transmitted from the UE-to-NE relay-1 terminal 107 operates as follows. The UE-to-NE relay-2 terminal 108 transmits a response message (acknowledgment or acceptance message) corresponding to the path switch request message to the UE-to-NE relay-1 terminal 107.

In step F1013, the UE-1 101 and the UE-2 102 perform connection processing via the UE-to-UE relay terminal 103.

In step F1014, the UE-1 101 and the UE-2 102 switch the previous transmission and reception of information through the Uu path via the base station, relayed by the UE-to-NE relay-1 terminal 107 and relay-2 terminal 108, to transmission and reception via the relay path. This relay path is the path via the UE-to-UE relay terminal 103.

After the switching to the relay path, in step F1015, the UE-to-NE relay-1 terminal 107 operates as follows. The UE-to-NE relay-1 terminal 107 determines whether the communication via the base station is being used by other applications or the like. If the connection with the base station is determined to not be needed, the UE-to-NE relay-1 terminal 107 releases (or disconnects) the connection.

After the switching to the relay path, in step F1016, the UE-to-NE relay-2 terminal 108 operates as follows. The UE-to-NE relay-2 terminal 108 determines whether the communication via the base station is being used by other applications or the like. If the connection with the base station is determined to not be needed, the UE-to-NE relay-2 terminal 108 releases (or disconnects) the connection.

In step F1017, the UE-1 101 and the UE-2 102 communicate with each other through the relay path via the UE-to-UE relay terminal 103.

As described above, according to the embodiment, the communication between the UEs can be switched between communication via a base station (communication via a Uu path) and communication not via a base station but via a relay UE (communication through a PC5 path via a relay). This can expand, for example, the coverage of high-speed low-power-consumption direct communication between UEs in proximity. Communication between terminal apparatuses where a relay apparatus may intervene can thereby be appropriately switched between communication via a base station and communication not via a base station.

### Third Embodiment

The first and second embodiments have dealt with path switching in a communication system where a UE-to-UE relay terminal and a UE-to-NE relay terminal or terminals exist separately. By contrast, a third embodiment deals with path switching in a communication system that includes a single relay terminal having the functions of both a UE-to-UE relay terminal and a UE-to-NE relay terminal. Note that where configurations and processes in the third embodiment are the same as or similar to those in the first or second embodiment, a description thereof may be omitted.

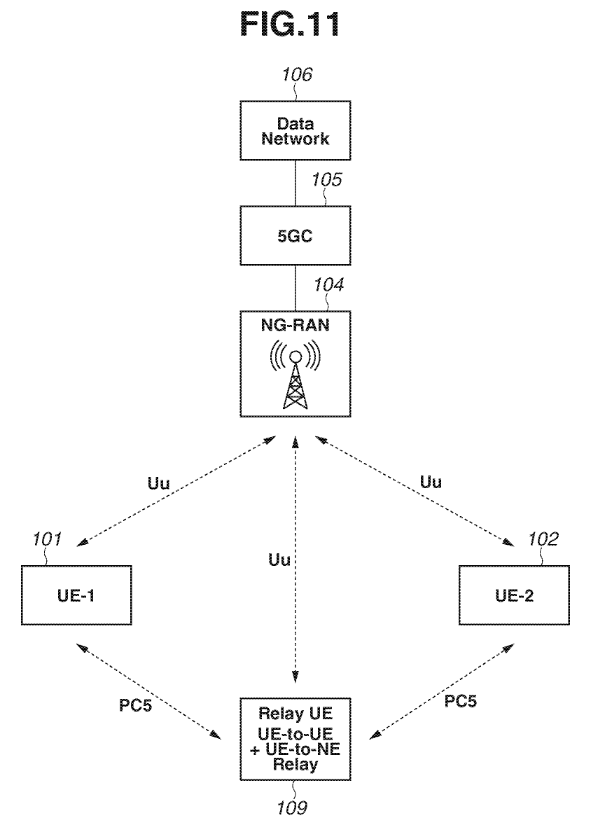

FIG. 11 is a diagram illustrating a configuration example of a communication system according to the third embodiment of the disclosure. The communication system illustrated in FIG. 11 has the configuration of the communication system illustrated in FIG. 1 from which the UE-to-UE relay terminal 103 and the UE-to-NE relay terminal 107 are removed and to which a relay UE 109 is added. Here, the relay UE 109 is configured as a single terminal having the function equivalent to that of the UE-to-UE relay terminal 103 and the function equivalent to that of the UE-to-NE relay terminal 107. The function equivalent to that of the UE-to-UE relay terminal 103 will be referred to as a UE-to-UE relay function. The function equivalent to that of the UE-to-NE relay terminal 107 will be referred to as a UE-to-NE relay function. The UE-to-UE relay function supports a communication method in which UEs communicate with each other without the intervention of a base station. The UE-to-NE relay function supports a communication method in which UEs communicate with each other via a base station. The relay UE 109 determines to switch the communication method by which UE-1 101 and the UE-2 102 communicate with each other. The relay UE 109 selectively uses its UE-to-UE relay function and UE-to-NE relay function based on the determination, and thereby relays communication between the UE-1 101 and the UE-2 102.

As will be described in detail below, the relay UE 109 decides to switch the communication method by which the UE-1 101 and the UE-2 102 communicate with each other, as follows. The relay UE 109 decides to switch the communication method to one for performing communication via the UE-to-NE relay terminal function of the relay UE 109 and the NG-RAN 104.

As will be described below, the relay UE 109 also decides to switch the communication method by which the UE-1 101 and the UE-2 102 communicate with each other, as follows. The relay UE 109 decides to switch the communication method to one for performing communication via the UE-to-UE relay terminal of the relay UE 109 and not via the NG-RAN 104.

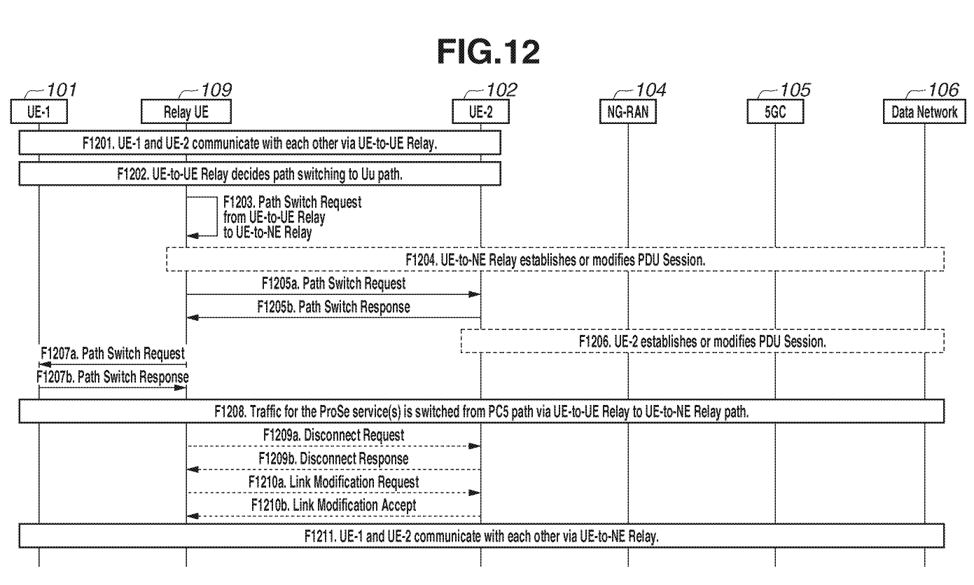

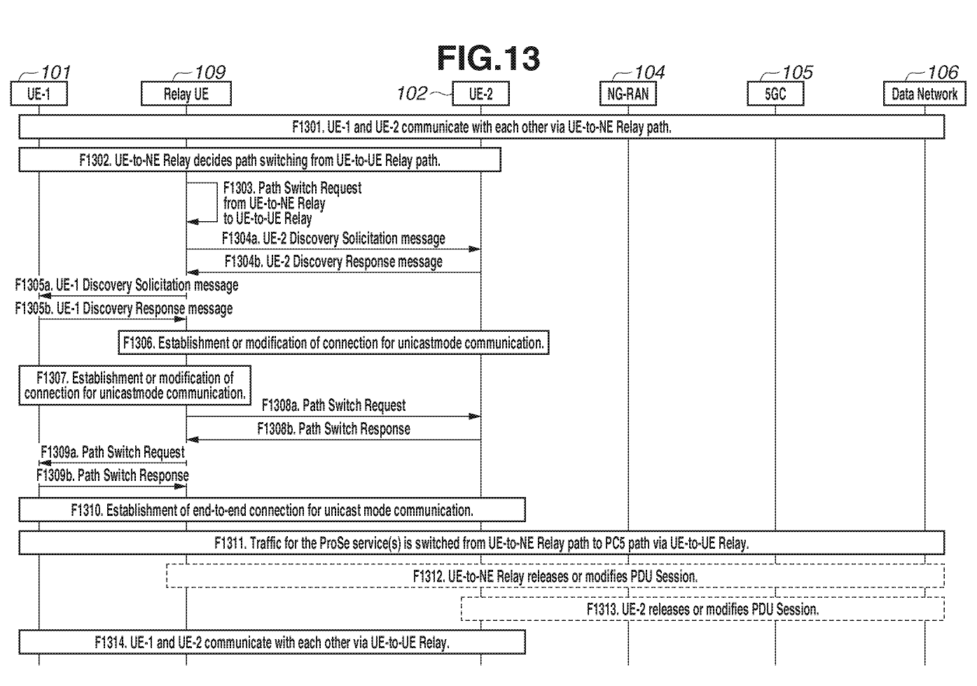

As the third embodiment, processing examples where the relative UE 109 relays communication between the UE-1 101 and the UE-2 102 will be described with reference to the sequence diagrams illustrated in FIGS. 12 and 13.

FIG. 12 is a sequence diagram illustrating a processing example when the communication between the UE-1 101 and UE-2 102 is switched from a relay path to a Uu path by using the UE-to-UE relay function and UE-to-NE relay function of the relay UE 109.

In step F1201, the UE-1 101 and the UE-2 102 communicate with each other through a relay path via the relay UE 109.

In step F1202, the relay UE 109 determines the conditions and decides (determines) to switch the communication between the UE-1 101 and the UE-2 102 from the currently used relay path to another path. In this example, the relay UE 109 decides (determines) to switch the communication between the UE-1 101 and the UE-2 102 to a Uu path via the base station, relayed by the relay UE 109. A detailed processing example (condition determination) of step F1202 is similar to that described above with reference to FIG. 6, and a description thereof will thus be omitted.

In step F1203, the relay UE 109 transmits a path switch request message between the internal functions of the relay UE 109. This path switch request message is intended to request switching of the communication between the UE-1 101 and the UE-2 102, relayed by the UE-to-UE relay function, to the Uu path relayed by the UE-to-NE relay function. This path switch request message is an example of a signal related to a relay apparatus (relay UE 109) that relays communication of the switched communication method between a first terminal apparatus (UE-1 101) and a second terminal apparatus (UE-2 102).

In step F1204, the UE-to-NE relay function in the relay UE 109 determines the connection status with the base station, and connects to the base station as needed.

In step F1205a, the relay UE 109 transmits a path switch request message to the UE-2 102. This path switch request message is a message for requesting switching of the communication between the UE-1 101 and the UE-2 102 to the Uu path via the base station, relayed by the UE-to-NE relay function of the relay UE 109.

In step F1205b, the UE-2 102 receiving the path switch request message transmitted from the relay UE 109 transmits a response message (acknowledgment or acceptance message) corresponding to the path switch request message to the relay UE 109.

In step F1206, the UE-2 102 determines the connection status with the base station, and connects to the base station as needed.

In step F1207a, the relay UE 109 transmits a path switch request message to the UE-1 101. This path switch request message is a message for requesting switching of the communication between the UE-1 101 and the UE-2 102 to the Uu path via the base station, relayed by the UE-to-NE relay function of the relay UE 109.

In step F1207b, the UE-1 101 receiving the path switch request message transmitted from the relay UE 109 transmits a response message (acknowledgment or acceptance message) corresponding to the path switch request message to the relay UE 109.

With the UE-2 and the relay UE 109 both connected to the base station, in step F1208, the UE-1 101 and the UE-102 operate as follows. The UE-1 101 and the UE-2 102 switch the communication path between the UE-1 101 and the UE-2 102 from the relay path (PC5 path) via the UE-to-UE relay function of the relay UE 109 to the Uu path. This Uu path is the path via the base station, relayed by the UE-to-NE relay function of the relay UE 109.

In step F1209a, the relay UE 109 transmits a disconnection request message for requesting disconnecting the connection or communication with the UE-2 102 to the UE-2 102 as needed. In step F1209b, the UE-2 102 transmits a response message (acknowledgment or acceptance message) corresponding to the disconnection request message to the relay UE 109 as needed.

In step F1210a, the relay UE 109 transmits a connection setting change request message for requesting a change in the connection setting with the UE-2 102 to the UE-2 102 as needed. In step F1210b, the UE-2 102 transmits a response message (acknowledgment or acceptance message) corresponding to the connection setting change request message to the relay UE 109 as needed.

In step F1211, the UE-1 101 and the UE-2 102 communicate with each other through the Uu path via the base station, relayed by the UE-to-NE relay function of the relay UE 109.

FIG. 13 is a sequence diagram illustrating a processing example when the communication between the UE-1 101 and the UE-2 102 is switched from a Uu path to a relay path by using the UE-to-UE relay function and UE-to-NE relay function of the relay UE 109.

In step F1301, the UE-1 101 and the UE-2 102 communicate with each other through a Uu path via the base station. The UE-1 101 is connected to the base station (for example, NG-RAN 104) via relaying by the UE-to-NE relay function of the relay UE 109.

In step F1302, the relay UE 109 determines the conditions and decides (determines) to switch the communication between the UE-1 101 and the UE-2 102 from the currently used Uu path to another path. In this example, the relay UE 109 decides (determines) to switch the communication between the UE-1 101 and the UE-2 102 to a relay path via the UE-to-UE relay function of the relay UE 109.

A detailed processing example (condition determination) of step F1302 is similar to that described above with reference to FIG. 7, and a description thereof will thus be omitted.

In step F1303, the relay UE 109 transmits a path switch request message between the internal functions of the relay UE 109. This path switch request message is intended to request switching of the communication between the UE-1 101 and the UE-2 102, relayed by the UE-to-NE relay function, to the relay path relayed by the UE-to-UE relay function. This path switch request message is an example of a signal related to a relay apparatus (relay UE 109) that relays communication of the switched communication method between the first terminal apparatus (UE-1 101) and the second terminal apparatus (UE-2 102).

In step F1304a, the relay UE 109 searches for (discovers) the UE-2 102 by transmitting a discovery solicitation message by PC5 communication.

In step F1304b, the UE-2 102 receiving the discovery solicitation message transmitted from the relay UE 109 transmits a response message to the discovery solicitation message.

In step F1305a, the relay UE 109 searches for (discovers) the UE-1 101 by transmitting a discovery solicitation message by PC5 communication.

In step F1305b, the UE-1 101 receiving the discovery solicitation message transmitted from the relay UE 109 transmits a response message to the discovery solicitation message.

In step F1306, the relay UE 109 performs connection processing with the UE-2 102 discovered by the search.

In step F1307, the relay UE 109 performs connection processing with the UE-1 101 discovered by the search.

In step F1308a, the relay UE 109 transmits to the UE-2 102 a path switch request message for requesting switching from the Uu path to the PC5 path. In step F1308b, the UE-2 102 receiving the path switch request message transmitted from the relay UE 109 transmits a response message (acknowledgment or acceptance message) corresponding to the path switch request message to the relay UE 109.

In step F1309a, the relay UE 109 transmits to the UE-1 101 a path switch request message for requesting switching from the Uu path to the PC5 path. In step F1309b, the UE-1 101 receiving the path switch request message transmitted from the relay UE 109 transmits a response message (acknowledgment or acceptance message) corresponding to the path switch request message to the relay UE 109.

In step F1310, the UE-1 101 and the UE-2 102 perform connection processing via the UE-to-UE relay function of the relay UE 109.

In step F1311, the UE-1 101 and the UE-2 102 switch the previous transmission and reception of information through the Uu path via the base station, relayed by the UE-to-NE relay function of the relay UE 109, to transmission and reception via the relay path. This relay is the path via the UE-to-UE relay function of the relay UE 109.

After the switching to the relay path, in step F1312, the relay UE 109 determines whether the communication via the base station is being used by other applications or the like. If the connection with the base station is determined to not be needed, the relay UE 109 releases (or disconnects) the connection.

After the switching to the relay path, in step F1313, the UE-2 102 determines whether the communication via the base station is being used by other applications or the like. If the connection with the base station is determined to not be needed, the UE-2 102 releases (or disconnects) the connection.

In step F1314, the UE-1 101 and the UE-2 102 communicate with each other through the relay path via the UE-to-UE relay function of the relay UE 109.

As described above, according to the embodiment, the communication between the UEs can be switched between communication via a base station (communication via a Uu path) and communication not via a base station (communication via a PC5 path). This can expand, for example, the coverage of high-speed low-power-consumption direct communication between UEs in proximity. Communication between terminal apparatuses where a relay apparatus may intervene can thereby be appropriately switched between communication via a base station and communication not via a base station.

### Other Embodiments

The disclosure can also be implemented by processing for supplying a program for implementing one or more functions of the foregoing embodiments to a system or an apparatus via a network or a storage medium, and reading and executing the program by one or more processors in a computer of the system or apparatus. The disclosure can also be implemented using a circuit that implements one or more functions (for example, ASIC or FPGA).

The disclosure is not limited to the foregoing embodiments, and various changes and modifications can be made without departing from the gist and scope of the disclosure.

The names of the functional units, messages, parameters, fields, and the like described in the foregoing embodiments are merely exemplary, and may be changed to other names.

Some of the message described in the foregoing embodiments may be included in other messages. For example, a path switch request message (Path Switch Request) may be included in a connection setting change request message (Link Modification Request).

The processing procedures, sequences, flowcharts, and the like in the foregoing embodiments are not limited to the specific order presented. The steps may be interchanged and/or additional steps may be added unless inconsistency results. Some of the steps may be omitted. For example, in FIG. 7, steps S701 to S704 may be interchanged in order. One or more and not more than three of the blocks of steps S701 to S704 may be omitted.

The matters described in the foregoing embodiments may be incorporated into other embodiments unless inconsistency results.

Concerning the foregoing embodiments, the following supplementary notes will be further disclosed.

### Supplementary Note 1

A first relay apparatus configured to relay communication between a first terminal apparatus and a second terminal apparatus, the first relay apparatus including a decision unit configured to decide to switch a communication method by which the first terminal apparatus and the second terminal apparatus communicate with each other between a first communication method for communicating via a base station and a second communication method for communicating without intervention of the base station, and a transmission unit configured to, based on the decision unit deciding to switch the communication method between the first communication method and the second communication method, transmit a signal related to a second relay apparatus configured to relay communication of the switched communication method between the first terminal apparatus and the second terminal apparatus.

### Supplementary Note 2

The first relay apparatus according to supplementary note 1, wherein the first relay apparatus and the second relay apparatus are different from each other, and wherein the transmission unit is configured to, based on the decision unit deciding to switch the communication method from the first communication method to the second communication method, transmit a search signal for searching for the second relay apparatus as the signal related to the second relay apparatus, the second relay apparatus being configured to not communicate with the base station.

### Supplementary Note 3

The first relay apparatus according to supplementary note 2, wherein the transmission unit is configured to transmit a signal requesting switching of the communication method from the first communication method to the second communication method to the second relay apparatus before the communication method is switched from the first communication method to the second communication method.

### Supplementary Note 4

The first relay apparatus according to supplementary note 1, wherein the first relay apparatus and the second relay apparatus are different from each other, and wherein the transmission unit is configured to, based on the decision unit deciding to switch the communication method from the second communication method to the first communication method, transmit a search signal for searching for the second relay apparatus as the signal related to the second relay apparatus, the second relay apparatus being configured to communicate with the base station.

### Supplementary Note 5

The first relay apparatus according to supplementary note 4, wherein the transmission unit is configured to transmit a signal requesting switching of the communication method from the second communication method to the first communication method to the second relay apparatus before the communication method is switched from the second communication method to the first communication method.

### Supplementary Note 6

The first relay apparatus according to supplementary note 1, wherein the first relay apparatus and the second relay apparatus are the same, wherein the first relay apparatus has a first function supporting the first communication method and a second function supporting the second communication method, and wherein the transmission unit is configured to, based on the decision unit deciding to switch the communication method from the first communication method to the second communication method, transmit from the first function to the second function a signal requesting switching of the communication method from the first communication method to the second communication method as the signal related to the second relay apparatus, the first function being configured to communicate with the base station, the second function being configured to not communicate with the base station.

### Supplementary Note 7

The first relay apparatus according to supplementary note 1 or 6, wherein the first relay apparatus and the second relay apparatus are the same, wherein the first relay apparatus has a/the first function supporting the first communication method and a/the second function supporting the second communication method, and wherein the transmission unit is configured to, based on the decision unit deciding to switch the communication method from the second communication method to the first communication method, transmit from the second function to the first function a signal requesting switching of the communication method from the second communication method to the first communication method as the signal related to the second relay apparatus, the second function being configured to communicate with the base station, the first function being configured to not communicate with the base station.

### Supplementary Note 8

The first relay apparatus according to any one of supplementary notes 1 to 7, wherein the decision unit is configured to decide to switch the communication method between the first communication method and the second communication method, based on an operating state of a service or application used between the first terminal apparatus and the second terminal apparatus.

### Supplementary Note 9

The first relay apparatus according to any one of supplementary notes 1 to 8, wherein the decision unit is configured to decide to switch the communication method between the first communication method and the second communication method, based on traffic between the first terminal apparatus and the second terminal apparatus.

### Supplementary Note 10

The first relay apparatus according to any one of supplementary notes 1 to 9, wherein the decision unit is configured to decide to switch the communication method from the first communication method to the second communication method, based on communication quality between the first relay apparatus and the base station in the first communication method.

### Supplementary Note 11

The first relay apparatus according to any one of supplementary notes 1 to 10, wherein the decision unit is configured to decide to switch the communication method from the first communication method to the second communication method, based on a remaining battery level of the first relay apparatus.

### Supplementary Note 12

The first relay apparatus according to supplementary note 2 or 6, wherein the transmission unit is configured to transmit a/the signal requesting switching of the communication method from the first communication method to the second communication method to the first terminal apparatus and the second terminal apparatus before the communication method is switched from the first communication method to the second communication method.

### Supplementary Note 13

The first relay apparatus according to supplementary note 4 or 7, wherein the transmission unit is configured to transmit a/the signal requesting switching of the communication method from the second communication method to the first communication method to the first terminal apparatus and the second terminal apparatus before the communication is switched from the second communication method to the first communication method.

### Supplementary Note 14

A control method of a first communication apparatus configured to relay communication between a first terminal apparatus and a second terminal apparatus, the control method including deciding to switch a communication method by which the first terminal apparatus and the second terminal apparatus communicate with each other between a first communication method for communicating via a base station and a second communication method for communicating without intervention of the base station, and based on the communication method being decided to be switched between the first communication method and the second communication method, transmitting a signal related to a second relay apparatus configured to relay communication of the switched communication method between the first terminal apparatus and the second terminal apparatus.

### Supplementary Note 15

A program for causing a computer of a relay apparatus to perform the control method according to supplementary note 14.

According to an aspect of the disclosure, a communication path between terminal apparatuses can be appropriately switched between paths where a relay terminal may intervene.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-063922, filed Apr. 8, 2025, which is hereby incorporated by reference herein in its entirety.

What is claimed is:

1. A first apparatus configured to relay communication between a first terminal apparatus and a second terminal apparatus, the first apparatus comprising:
a decision unit configured to decide to switch a communication method by which the first terminal apparatus and the second terminal apparatus communicate with each other between a first communication method for communicating via a base station and a second communication method for communicating without intervention of the base station; and
a transmission unit configured to, based on the decision unit deciding to switch the communication method between the first communication method and the second communication method, transmit a signal related to a second apparatus configured to relay communication of the switched communication method between the first terminal apparatus and the second terminal apparatus.

2. The first apparatus according to claim 1,
wherein the first apparatus and the second apparatus are different from each other, and
wherein the transmission unit is configured to, based on the decision unit deciding to switch the communication method from the first communication method to the second communication method, transmit a search signal for searching for the second apparatus as the signal related to the second apparatus, the second apparatus being configured to not communicate with the base station.

3. The first apparatus according to claim 2, wherein the transmission unit is configured to transmit a signal requesting switching of the communication method from the first communication method to the second communication method to the second apparatus before the communication method is switched from the first communication method to the second communication method.

4. The first apparatus according to claim 1,
wherein the first apparatus and the second apparatus are different from each other, and
wherein the transmission unit is configured to, based on the decision unit deciding to switch the communication method from the second communication method to the first communication method, transmit a search signal for searching for the second apparatus as the signal related to the second apparatus, the second apparatus being configured to communicate with the base station.

5. The first apparatus according to claim 4, wherein the transmission unit is configured to transmit a signal requesting switching of the communication method from the second communication method to the first communication method to the second relay apparatus before the communication method is switched from the second communication method to the first communication method.

6. The first apparatus according to claim 1,
wherein the first apparatus and the second apparatus are the same,
wherein the first apparatus has a first function supporting the first communication method and a second function supporting the second communication method, and
wherein the transmission unit is configured to, based on the decision unit deciding to switch the communication method from the first communication method to the second communication method, transmit from the first function to the second function a signal requesting switching of the communication method from the first communication method to the second communication method as the signal related to the second apparatus, the first function being configured to communicate with the base station, the second function being configured to not communicate with the base station.

7. The first apparatus according to claim 1,
wherein the first apparatus and the second apparatus are the same,
wherein the first apparatus has a first function supporting the first communication method and a second function supporting the second communication method, and
wherein the transmission unit is configured to, based on the decision unit deciding to switch the communication method from the second communication method to the first communication method, transmit from the second function to the first function a signal requesting switching of the communication method from the second communication method to the first communication method as the signal related to the second apparatus, the second function being configured to communicate with the base station, the first function being configured to not communicate with the base station.

8. The first apparatus according to claim 1, wherein the decision unit is configured to decide to switch the communication method between the first communication method and the second communication method, based on an operating state of a service or application used between the first terminal apparatus and the second terminal apparatus.

9. The first apparatus according to claim 1, wherein the decision unit is configured to decide to switch the communication method between the first communication method and the second communication method, based on traffic between the first terminal apparatus and the second terminal apparatus.

10. The first apparatus according to claim 1, wherein the decision unit is configured to decide to switch the communication method from the first communication method to the second communication method, based on communication quality between the first apparatus and the base station in the first communication method.

11. The first apparatus according to claim 1, wherein the decision unit is configured to decide to switch the communication method from the first communication method to the second communication method, based on a remaining battery level of the first apparatus.

12. The first apparatus according to claim 2, wherein the transmission unit is configured to transmit a/the signal requesting switching of the communication method from the first communication method to the second communication method to the first terminal apparatus and the second terminal apparatus before the communication method is switched from the first communication method to the second communication method.

13. The apparatus according to claim 6, wherein the transmission unit is configured to transmit a/the signal requesting switching of the communication method from the first communication method to the second communication method to the first terminal apparatus and the second terminal apparatus before the communication method is switched from the first communication method to the second communication method.

14. The first apparatus according to claim 4, wherein the transmission unit is configured to transmit a/the signal requesting switching of the communication method from the second communication method to the first communication method to the first terminal apparatus and the second terminal apparatus before the communication is switched from the second communication method to the first communication method.

15. The first apparatus according to claim 7, wherein the transmission unit is configured to transmit a/the signal requesting switching of the communication method from the second communication method to the first communication method to the first terminal apparatus and the second terminal apparatus before the communication is switched from the second communication method to the first communication method.

16. A method of a first communication apparatus configured to relay communication between a first terminal apparatus and a second terminal apparatus, the method comprising:
deciding to switch a communication method by which the first terminal apparatus and the second terminal apparatus communicate with each other between a first communication method for communicating via a base station and a second communication method for communicating without intervention of the base station; and
based on the communication method being decided to be switched between the first communication method and the second communication method, transmitting a signal related to a second apparatus configured to relay communication of the switched communication method between the first terminal apparatus and the second terminal apparatus.

17. The method according to claim 16, wherein the decision decides to switch the communication method from the first communication method to the second communication method, based on (i) communication quality between the first apparatus and the base station in the first communication method or (ii) a remaining battery level of the first apparatus.

18. A storage medium storing a program for causing a computer of an apparatus to perform a control method of a first communication apparatus configured to relay communication between a first terminal apparatus and a second terminal apparatus, the control method comprising:
deciding to switch a communication method by which the first terminal apparatus and the second terminal apparatus communicate with each other between a first communication method for communicating via a base station and a second communication method for communicating without intervention of the base station; and
based on the communication method being decided to be switched between the first communication method and the second communication method, transmitting a signal related to a second apparatus configured to relay communication of the switched communication method between the first terminal apparatus and the second terminal apparatus.

19. The storage medium according to claim 18, wherein the decision decides to switch the communication method from the first communication method to the second communication method, based on (i) communication quality between the first apparatus and the base station in the first communication method or (ii) on a remaining battery level of the first apparatus.
